(19) United States
(12) Patent Application Publication
(10) Pub. No.: US 2015/0264420 A1
(43) Pub. Date: Sep. 17, 2015

(54) METHOD FOR CONTROLLING THE DISPLAY OF A DIGITAL TELEVISION SET

(71) Applicant: IFEELSMART, Paris (FR)

(72) Inventors: Shy Shriqui, Paris (FR); Xavier Bringue, La Garenne Colombes (FR); Jeremie Guerinel, Paris (FR)

(21) Appl. No.: 14/426,643

(22) PCT Filed: Sep. 3, 2013
(86) PCT No.: PCT/FR2013/052017

§ 371 Date: Mar. 6, 2015

(30) Foreign Application Priority Data
Sep. 10, 2012 (FR) 12 58447

(51) Int. Cl. H04N 21/418; H04N 21/8543; H04N 21/81; H04N 21/643; H04N 21/858; H04N 21/433; H04N 21/258; H04N 21/2668; H04N 21/435; H04N 21/4623; H04N 21/2665; H04N 21/478

(52) U.S. Cl. CPC H04N 21/4181; H04N 21/2665; H04N 21/8543; H04N 21/8173; H04N 21/64322; H04N 21/4781; H04N 21/47805; H04N 21/4332; H04N 21/25875; H04N 21/2668; H04N 21/435; H04N 21/4623; H04N 21/858

(57) ABSTRACT

The present invention relates to a method for controlling the display of a multimedia data television set combining one or more graphic or video contents as well as areas of contextual information concerning the state of the television set and the available functionalities thereof. The method comprises a step of installing, on the television set, a secure software application comprising means dedicated to executing an operation for personalizing the infographic context as well as for opening dynamic connectors toward functionalities, depending, at least, on one identifier from an external means.

### CROSS-REFERENCE TO RELATED APPLICATIONS

This application is a national phase entry under 35 U.S.C. §371 of International Patent Application PCT/FR2013/052017, filed Sep. 3, 2013, designating the United States of America as International Patent Publication WO 2014/037660 A1 on Mar. 13, 2014, which claims the benefit under Article 8 of the Patent Cooperation Treaty and under 35 U.S.C. §119(e) to France Application Serial No. 1258447, filed Sep. 10, 2012, the disclosure of each of which is hereby incorporated herein in its entirety by this reference.

### TECHNICAL FIELD

The present invention relates to the field of digital television and more particularly digital television associated with or incorporating a digital television decoder enabling a subscriber to receive a multitude of television programs, or services.

### BACKGROUND

In this patent “television set” will mean a television set connected to a peripheral decoder as well as a television set incorporating a decoder.

The equipment of a user involves several actors:
the manufacturer of the television set or the generic decoder and the sellers thereof;
the services operator providing a subscription associated with a proprietary decoder or a card controlling a decoder or a generic television set;
providers of services and contents available through or outside the operators' offers, such as the catalogs of content such as video on demand, application platforms (appstores), Internet video services, etc.

Services operator means any content and/or services providing operator giving access to programs, content, television services, audio-visual or application digital content, related metadata, and catalogs of audiovisual or application digital content.

In the prior art, each decoder leased is usually programmed to decrypt the television services emitted by a single operator. A particular application, also called a locking application of the program memory which locks the operation of the decoder on the only operator authorized by the decoder. In most cases, such locking is activated upon manufacturing of the decoder.

The European Patent EP1814331 is known in the state of the art, which discloses a method for identifying, within a digital television decoder, an authorized operator, with the decoder particularly comprising a data memory, a program memory and an access control module checking that a rights management card inserted into the decoder is an authorized card, with the card comprising, in a memory unit, an item of information relating to its being the property of a particular operator, characterized in that the method comprises the different steps of:
storing in the data memory a list of authorized operators, with the list comprising at least a first operator (code 1) and a second operator (Code 2);
checking, using an access control module, that the particular operator which the card belongs to is one of the operators in the list of authorized operators; authorizing a normal operation of the decoder, if need be only.

The U.S. Patent Publication No. 2009/00144766 is also known, which describes a “universal” cable-decoder enabling to install the decryption application after the sale, using an authentication and downloading system via the multi-broadcast video signal.

This solution of the prior art makes it possible to download a file containing the keys for activating new services via the multi-broadcast signal.

The solution provided by the U.S. Patent Publication No. 2009/00144766 does not make it possible to adapt to each operator's offer for special services, and cannot be implemented without an operator. This solution does not make it possible either to change the infographics, but only to control the security scheme of the decoder.

The solution provided by the patent EP1814331 or in the Cutts Article of the prior art is very restrictive. It is compatible only with situations where operators (a) use a rights management memory card and (b) previously saved in the operator's memory and the settings (c) of which are saved upon manufacturing of the decoder.

This solution of the prior art is not adapted to the context of a connected television set, involving the emergence of offers for service without operators (“over the top”).

In this case, the compulsory link between the access to services and the provision by an operator of a decoder at the time of the subscription is no longer appropriate.

Moreover, in the solutions of the prior art, the configuration data for each operator is a priori saved in the memory of the decoder at the time of the manufacturing thereof. However, the currently available services are changing very quickly, and the proposed solution does not make it possible to satisfactorily follow such rapid changes.

The solution of the prior art is also limited to the switching between the pre-registered operators without any possibility to dynamically add an operator or dynamically edit the parameters of a pre-registered operator.

Eventually, the solution of the prior art does not make it possible to manage a hybrid with operator/without operator operation, for example, in equipment marketed outside the operator's network. It does not enable synchronizing with connected peripheral devices either.

The transmitted file makes it possible to update the package of services, for example, to decrypt an additional channel, but not the television set configuration, more particularly the infographics thereof, and interactive services other than the simple selection of a channel.

### BRIEF SUMMARY

Unlike the solutions of the prior art, the main objective of the invention is not the subsequent configuration of the access control, but the personalization of the functionalities of a television set marketed according to a universal initial mode.

In order to remedy the drawbacks of the prior art, the present invention, in its broadest sense, relates to a method for controlling the display of a multimedia data television set combining one or more graphic or video contents as well as areas of contextual information concerning the state of the television set and the available functionalities thereof, characterized in that it comprises a step of installing, on the television set, a secure software application comprising means dedicated to executing an operation for personalizing the infographic context as well as for opening dynamic connectors toward functionalities, depending on at least one item of information from an external means.

The invention makes it possible for the manufacturing and the supply of the generic television set (or the decoder), and the utilization thereof within the scope of an operator's offer, fully independent of one another or even independent of the operator (“over the top” model).

The television set includes a memory wherein is a unique identifier is saved. During the step of initial or subsequent installation, a computer application is executed by the television set to perform the following tasks:
Logging on via an Internet protocol with a platform the address of which is saved directly or indirectly in the television set memory.
Transmission, by the television set to the platform, of the unique identifier of the television set and of the identifier of the service provider from the external means, for instance, a memory card or any other known means.
Checking by the platform of a valid association of the identifiers (unique identifier of the television set and identifier of the service provider). Such checking makes it possible to reduce the risk of fraud or misuse of the configuration by an unauthorized user: fraudulent possession of the second identifier does not make it possible to get a new configuration for a third party who does not own the television set wherein the first identifier is registered.
In case of invalidity of the association, the television set remains in its initial state, and optionally displays an information message about the invalidity of the combination of the equipment identifier and the identifier of the service provider.
In case of validity of the association, transmission by the platform of a configuration file saved in the television set memory, and execution of a configuration program taking into account the parameters contained in the configuration file.

Implementing these tasks require the capacity of establishing a bidirectional dialogue between the television set and the platform associated with the television set. Such a solution is not possible with the methods of the prior art such as the one provided in U.S. Patent Publication No. 2009/144766. This document mentions no identifier of the terminal enabling the identification thereof. The configuration file is “pushed” by the network in a multi-broadcast stream.

The invention, thus, provides a generic television set with its own offer for services which dynamically evolves at the manufacturer's discretion, with the latter determining offers for services through an external database, for example, on a server. It also enables receiving offers for services from operators which are the manufacturer's partners, with the list of such operators being dynamically evolving as well as the services provided by these operators.

It also makes it possible to edit the configuration to switch from an access to a catalog of video on demand from a distribution platform to another catalog.

It also makes it possible to ensure the security of such changes, by preventing the hacking of another user's subscription, for instance, by capturing the stream on the cable in an apartment building or a multi-broadcast stream.

According to a first alternative solution, the identifier from an external means is saved in a secure memory card further comprising means for processing cryptographic functions.

According to a second alternative solution, the identifier from an external means is transmitted through the network of a content providing and/or services providing operator according to a mode of identification and authentication by a server.

According to a third alternative solution, the identifier from an external means consists of information exchanged with the local network access point of the service providing operator.

According to a fourth alternative solution, the identifier from an external means is determined by a user authentication means.

According to a fifth alternative solution, the identifier from an external means consists of an identifier from a third party device connected to the HDMI input on the television set (or of the decoder).

According to a sixth alternative solution, the identifier is written by composition into the video signal transmitted to the television set (or to the decoder).

Advantageously, the personalization data is saved in a profile as a configuration file of the XML type containing the available services identifiers as well as the infographics identifiers specific to the profile.

According to a particular implementation, the data for personalizing the functions which may be activated is saved in a configuration file of the XML type containing the configuration parameters of the available services by opening the corresponding data connectors.

According to a particular implementation, the data for personalizing the television set is propagated on at least a part of the connected peripheral devices.

Advantageously, the infographic data is saved in a configuration file of the XML type.

The services personalization data is preferably saved in one or more connectors as binary files the local execution of which, after installation in the decoder, gives access to the services.

According to an advantageous alternative solution, the method comprises steps of updating the connectors registered in the decoder.

According to a particular implementation, the method comprises connectors for an interactive content service linked with a broadcast content, enabling a TV channel to dynamically associate an environment of links toward third party content with a broadcast content.

The invention also relates to a digital television set characterized in that it comprises means for controlling the display of multimedia data combining one or more graphics or video content as well as areas of contextual information concerning the state of the television set and the available functionalities thereof and a secure software application comprising means dedicated to executing an operation for personalizing the infographic context as well as for opening dynamic connectors toward functionalities, depending, at least, on one item of information from an external means.

The digital television set, according to the invention, preferably comprises a plurality of connectors which may be dynamically activated for having access to services on the basis of the item of information from an external means.

### BRIEF DESCRIPTION OF THE DRAWINGS

The invention will be better understood upon reading the following description, corresponding to non-restrictive embodiments illustrated by the appended drawings wherein:

FIG. 1 represents a schematic view of the general architecture.

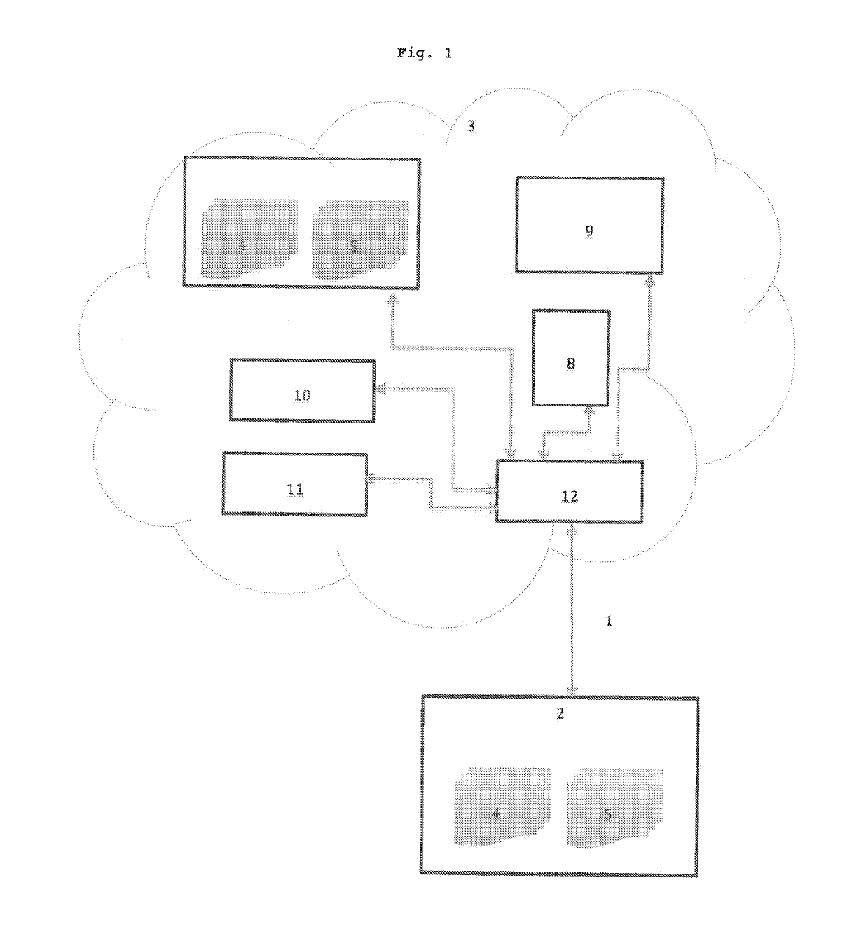

FIG. 2 shows an overview of the architecture of the decoder.

### DETAILED DESCRIPTION

The invention implements a decoder 2 (a “set top box”) of a known type, which can be integrated into a television set or be a peripheral device connected to a television set.

In this patent “television set” shall mean a television set incorporating a decoder as well as an assembly formed by a television set and an external decoder which can be connected to the television set.

The decoder 2 comprises a memory area 40 for registering computer personalization objects from a network door 1 giving access to information from an application server 3, which the decoder 2 communicates with according to an Internet protocol.

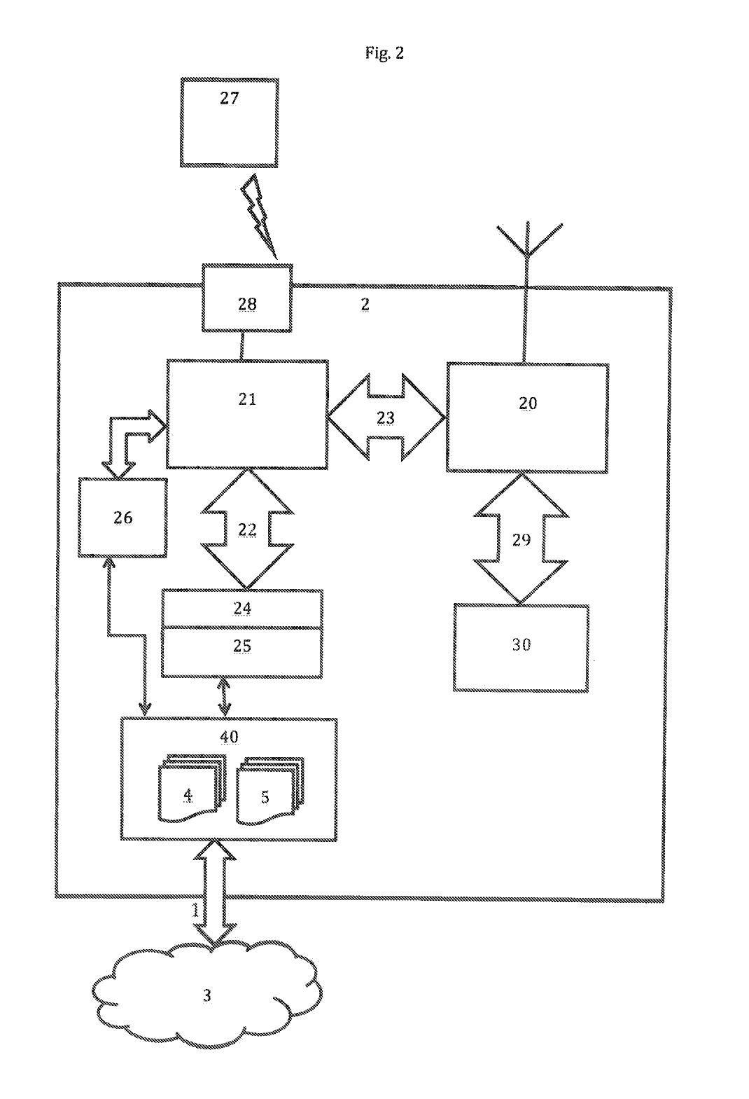

The general architecture of the decoder is shown in FIG. 2. It knowingly comprises a receiving and demultiplexing module 20, a microprocessor 21, a first bi-directional communication bus 22, 23, a program memory 24, the data memory 25, an access control module 26.

The decoder is generally driven by a remote control 27 communicating through an RF, Wifi or infrared link through a sensor 28 provided in the decoder 2. This remote control 27 is formed either by a dedicated device or by a cell phone or a tablet wherein an application, which can be executed for providing the decoder 2 driving functions, is installed.

A link 29 provides the transmission of the signals from the receiving module 20 to the decryption and audio/video decompressing module 30.

The program 24 and data 25 memory as well as the access control module 26 are connected to the memory assembly 40 wherein the connectors 4 and the extension modules 5, downloaded from a service platform located in the application server 3, are registered.

The application server 3 provides access to digital objects comprising:
a collection of connectors 4, of the “service platform clients” type;
a collection of extension modules 5 of the “plug-in” type intended to add functionalities and to adapt the application managing the decoder 2 interface.

The application server 3 comprises an updating manager 10, a profile manager 11 and a server application 12.

Description of the Profile Manager

A profile is determined for each “manufacturer/operator” couple as well as for a “manufacturer alone with no operator” mode.

This profile defines a list of services available to the concerned “manufacturer/operator” couple. One or more connector(s) is/are associated with each service.

Each profile is associated with a configuration file controlling specific infographics.

The services and functionalities are not restrictively of the following type:
program guide
television service map
VOD catalog
application platform
gaming platform
recommendation engine
billing system
. . . .

A profile is constructed by the manufacturer in connection with the concerned operator, if need be. It comprises a first unique signature corresponding to the identification of the decoder 2 which it is intended for, and a second signature associated with the concerned service operator corresponding to the identification of the operator using a known mechanism (network identification, memory card, etc.).

Each decoder 2 is physically associated with a first hardware identifier and optionally with one or more second operator identifier(s). This/these identifier(s) is/are saved in a computer memory of the decoder.

If there is no second “operator” identifier, the offer for service is the manufacturer's, and the latter then plays the role of the service operator.

When first installing or resetting a decoder 2, or when detecting a new operator identifier, the decoder controls the opening of an exchange of information with a profile manager, installed in the services platform 3.

The detection of a new operator may result from the detection of a registered operator identifier:
either in a memory card supplied by the service operator;
or through an identifier of the local network wherein the decoder 2 is installed;
or through an identifier of the telecommunication operator which the decoder user subscribes with;
or through an authentication of the decoder user through a dialogue via a specific interface;
or through an authentication initiated by a control peripheral device, for instance, the cell phone wherein the identifier of the cell operator is saved and authorized to transmit it to the decoder 2;
or through an identifier of a third party audiovisual device transmitted to the decoder 2 over the HDMI connection;
or through an identifier of written by composition into the video signal transmitted to the decoder 2.

This dialogue will consist in transmitting the first and second identifiers of the decoder concerned using a secure protocol (https, secure web service, XML-RPC, etc.) from the decoder to the profile manager.

The recognition of this unique couple of identifiers determines the corresponding specific profile.

This profile consists of an assembly of connectors and configuration files which are transmitted to the concerned decoder.

Detailed Description of an Exemplary Connector

The connectors 4 are applications which are intended to be downloaded by the decoder, installed in the personalization memory area 40. These applications executed as background tasks in the decoder 2 to establish the communications with a service platform and to retrieve the metadata relating to the video on demand (VOD), for example, or to the program guides (EPG), or the application stores (appstores). Such metadata is associated with additional elements such as images, thumbnails of the VOD content, texts, etc. Such personalization metadata is locally saved in the personalization memory 40 of the decoder 2 within the scope of the execution of the connector 4 by the decoder 2.

The decoder 2 comprises a generic application 6 for managing the interface, the operation of which is modified by the extension module(s) 5 downloaded and installed in the decoder 2.

A first example relates to a video on demand connector.

It consists of a digital file using a binary code saved in the application server. It is signed by the service operator with a unique identifier of the connector. The code of the connector contains:
an application which can be executed by the decoder 2 after downloading in the decoder from the application server 3;
metadata specific to an operator. Such metadata includes, in the case of a video-on-demand service, textual and graphic information each describing the contents of the catalog, the address and the mode of reading of such content, the security scheme, if any, to be activated to enable the reading of the content;
configuration information for the infographics specific to the service concerned.

The executable application fulfills the following functions:
it controls the loading or the updating of the local database of the video on demand catalog, into/in the memory of the decoder 2;
it activates or deactivates the hardware or software security mechanisms of the decoder required by the service.

For a digital IPTV television service, it consists of a digital file using a binary code saved on the application server. It is signed by the considered digital television services operator, with a unique identifier of the connector. The code of the connector contains:
an application which can be executed by the decoder 2 after downloading into the decoder from the application server 3;
metadata specific to an operator. Such metadata includes:
   a service map consisting of a list of channels accessible to the user;
   the addresses of the channels;
   the addresses of the programs mosaics;
   information from the electronic program guide.

The connector for a digital television service also comprises a configuration file for the means for securing the video stream from the concerned operator so as to allow the reading thereof by the decoder.

A third example relates to a connector for the billing service.

This connector contains information that also determines the access path to a billing platform 8 connected to the decoder. This billing platform 8 manages the transactions with the operators and more particularly the authorizations of accesses to charged services or content, and the activation or deactivation of charged services or content. According to this first alternative solution, a connector 4 is pre-installed in the decoder at the time of the manufacturing thereof

A fourth example relates to a connector for a service of interactive content related to a broadcast content.

Such a service enables a television channel to dynamically associate an environment of links toward third-party content or services with a broadcast content, for example:
a link giving access to a film on demand on a VOD platform of the channel;
a link executing an application provided by the channel, with such application being, for example, a game;
a link toward a website of the channel or a partner of the channel, etc.

This service is managed by the channel through an access specific to the platform 3, which enables it to determine the links it wants to associate with its content.

The connector 4 comprises an application for configuring the data presentation interface dynamically modifying the parameters of the default request generated by the user browsing the various services of the decoder. The changed parameters take into account the parameters determined by the channel on the service platform.

Description of the Updating Manager

The decoder also comprises an updating manager conducting a periodic audit of the connectors 4 and of the extension modules 5 installed in the decoder. Upon detection of the availability of new connectors 4 or new extension modules 5 on the application platform 3, the updating manager will command the downloading and the installation of the new digital objects or the new versions of the digital objects previously installed.

System Initialization

The television set or the decoder 2 is supplied with a minimum service configuration making it possible to:
Manage the access to a server hosting a service platform 3 hosting connectors selected by the decoder provider and/or a partner of the provider and a profile manager.
Execute, in the absence of communication with the service platform 3, an offer for default service via a connector pre-installed by the manufacturer of the decoder 2. This pre-installed connector allows access to the associated services.

This procedure makes it possible to use a generic decoder for all the operation modes and the partnership between the service providers and the operators.

The connectors 4 and the extension modules 5 are regularly monitored to ensure the automatic updating thereof.

They can be replaced or removed in case of expiry or in the event of a change in the services operator, without any other action on the decoder 2 or the television set. These changes are taken into account after restarting the decoder 2.

If the television set or the decoder is associated with one or more remote control(s) of the cell phone or tablet types, the personalization data, more particularly the data defining the graphic interface are passed on to the equipment by the decoder upon installation of a new extension module 5 or the updating thereof or upon the first connection of a new device or when changing the service operator.

1. A method for controlling the display of a multimedia data television set combining one or more graphic or video contents as well as areas of contextual information concerning a state of the television set and available functionalities thereof, the method comprising:
a step of initial configuration, of the television set, controlling default functionalities of a default operation of the television set; and
a step of installing, on the television set, at least one configuration file from a server with which the television set has a bidirectional communication according to an Internet protocol, the configuration file comprising software dedicated to executing an operation for personalizing infographic context of the television set using personalization data, as well as for opening dynamic connectors toward additional functionalities, the additional functionalities being added to the default functionalities or substituted for the default functionalities, depending, at least, on one identifier from an external means, with the additional functionalities comprising at least functionalities of access to a catalog of videos on demand, functionalities of access to an application or games downloading platform, functionalities for registering in a broadcast content network, functionalities of access to an e-commerce platform, functionalities for a personalization of the infographic context differing from the infographic context in the default operation of the television set, and functionalities of access to an online payment platform.

2. The method of claim 1, wherein the identifier from the external means is saved in a secure memory card further comprising software for processing cryptographic functions.

3. The method of claim 1, wherein the identifier from the external means is transmitted through the network of a content providing operator according to a mode of identification and authentication by a server.

4. The method of claim 1, wherein the identifier from the external means comprises information exchanged with a local network access point of the content providing operator.

5. The method of claim 1, wherein the identifier from the external means comprises information corresponding to the telecommunication operator associated with a connected remote control peripheral device.

6. The method of claim 1, the identifier from an external means is determined by a user authentication means.

7. The method of claim 1, wherein the identifier from the external means comprises information from a third party audio-visual device, exchanged through an HDMI connection between the third party audio-visual device and the television set.

8. The method of claim 1, wherein the identifier from the external means comprises information written by composition into a video signal received by the television set.

9. The method of claim 1, wherein the personalization data is saved in a profile as a configuration file of the XML type containing the available service identifiers, as well as the identifiers for the infographic context specific to the profile.

10. The method of claim 1, wherein data defining the infographic context is saved in a configuration file of the XML type in memory of the television set.

11. The method of claim 1, wherein the personalization data is saved in one or more connectors as binary files the local execution of which, after the installation thereof in the decoder, gives access to the services to a user of the television set.

12. The method of claim 1, wherein the personalization data is propagated on at least a part of one or more peripheral devices connected to the television set.

13. The method of claim 1, further comprising updating the connectors.

14. The method of claim 1, wherein the connectors include connectors for an interactive content service linked to a broadcast content, enabling a television channel to dynamically associate an environment of links toward third party content with a broadcast content.

15. A digital television set, comprising means for controlling the display of multimedia data combining one or more graphics or video content as well as areas of contextual information concerning a state of the television set and available functionalities thereof and a secure software application dedicated to executing an operation for personalizing infographic context of the television set as well as for opening dynamic connectors toward functionalities, depending, at least, on an item of information from an external means.

16. The digital television set of claim 15, further comprising a plurality of dynamically activated connectors providing access to services on the basis of the item of information from the external means.
